(19) United States
(12) Patent Application Publication
(10) Pub. No.: US 2017/0126815 A1
(43) Pub. Date: May 4, 2017

(54) SYSTEM AND METHOD FOR CHAINING VIRTUALIZED NETWORK FUNCTIONS

(71) Applicant: Electronics and Telecommunications Research Institute, Daejeon (KR)

(72) Inventors: Tae-Yeon KIM, Daejeon (KR); Bhum-Cheol LEE, Daejeon (KR)

(21) Appl. No.: 15/269,240

(22) Filed: Sep. 19, 2016

(30) Foreign Application Priority Data
Nov. 3, 2015 (KR) 10-2015-0153853

(51) Int. Cl. H04L 29/08; H04L 12/911; H04L 12/917

(52) U.S. Cl. CPC H04L 67/16; H04L 47/76; H04L 47/78

(57) ABSTRACT

A system for chaining a virtualized network function according to an example comprises: a forwarder configured to receive an input packet; and a broker configured to detect NFP_id of the input packet by referring to a network forwarding path (NFP) mapping table provided by an orchestrator and transfer the NFP_id and data of the input packet to a virtualized network function (VNF), wherein the broker receives a downlink packet including the NFP_id, branch_id and data from the VNF, constructs a header in accordance with the NFP_id or next NFP_id which corresponds to the branch_id on the NFP mapping table, and transfers an output packet including data included in the downlink packet and the header to the forwarder, wherein the forwarder transfers the output packet in accordance with the header of the output packet.

### CROSS REFERENCE TO RELATED APPLICATION

This application claims the benefit under 35 U.S.C. §119(a) of Korean Patent Application No. 10-2015-0153853 filed on Nov. 3, 2015 in the Korean Intellectual Property Office, the entire disclosure of which is incorporated herein by reference for all purposes.

### BACKGROUND

1. Field

The following description relates to a technology for a chaining virtualized network function (VNF) and more particularly, to a technology for chaining between a system and a virtualized network function.

2. Description of Related Art

NFV (Network Functions Virtualization) technology offers a new way to create new services through efficient integrated management of computing resources and network resources.

For the VNF chaining technology to become useful, each VNF is required to include a logic which is able to chain. However, the VNF may be preferred to be provided from VNF benders due to its own independent functions. Thus, when the logic for the VNF chaining is required to be included in the VNF, VNF benders have to pay a lot of money to construct the logic.

Furthermore, when each VNF needs a different logic in accordance with a different chaining method, additional logics are required to link different chaining methods between VNFs in the VNF. All VNFs have to be continuously modified or updated whenever the chaining method is added or changed. This requires a fairly large amount of money.

Since a chaining method structured for each VNF to include logics for different chaining methods is a system-dependent method, it causes serious problems to independence of the VNF when the VNF processes a system-related chaining logic.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An object of the following disclosure is to provide a system for chaining a virtualized network function which ensures independence for a plurality of VNFs.

According to one general aspect, a system for chaining a virtualized network function includes: a forwarder configured to receive an input packet; and a broker configured to detect NFP_id of the input packet by referring to a network forwarding path (NFP) mapping table provided by an orchestrator and transfer the NFP_id and data of the input packet to a virtualized network function (VNF), wherein the broker receives a downlink packet including the NFP_id, branch_id and data from the VNF, constructs a header in accordance with the NFP_id or next NFP_id which corresponds to the branch_id on the NFP mapping table, and transfers an output packet including data included in the downlink packet and the header to the forwarder, and wherein the forwarder transfers the output packet in accordance with the header of the output packet.

The broker may construct the header in accordance with the NFP_id when the branch_id of the downlink packet represents that there is no branch. On the other hand, the broker may construct the header in accordance with the next NFP_id which corresponds to the branch_id and the NFP_id on the NFP mapping table when the branch_id of the downlink packet represents that there is a branch.

The broker may include a VNF interface configured to receive the downlink packet from the VNF; a forwarder interface configured to receive the input packet from the forwarder; a classifier configured to detect NFP_id of the input packet or the downlink packet; and a mapper configured to transfer interface information corresponding to the NFP_id of the input packet by referring to the NFP interface table provided by the orchestrator to the VNF interface, obtain interface information corresponding to the NFP_id of the downlink packet by referring to the NFP interface table, and generate the header in accordance with the interface information, wherein the VNF interface may construct network interface or system interface in accordance with the interface information, and wherein the forwarder interface may transfer the output packet including the header to the forwarder.

The broker may detect NFP_id included in the header of the input packet as NFP_id of the input packet when the NFP_id is included in the header of the input packet. On the other hand, the broker may detect NFP_id corresponding to input port information of the input packet and the header of the input packet on the NFP mapping table as NFP_id of the input packet when the NFP_id is not included in the header of the input packet.

According to another general aspect, a system for chaining a virtualized network function includes an orchestrator configured to provide a NFP mapping table; and a brokering forwarder configured to receive an input packet, detect NFP_id of the input packet by referring to the NFP mapping table, and transfer the NFP_id and data of the input packet to a virtualized network function (VNF), wherein the brokering forwarder may receive a downlink packet including the NFP_id, branch_id and data from the VNF, generate a header corresponding to the NFP_id or next NFP_id which corresponds to the branch_id on the NFP mapping table, and transfers data included in the downlink packet and an output packet including the header through a path in accordance with the header.

The brokering forwarder may construct the header in accordance with the NFP_id when the branch_id of the downlink packet represents that there is no branch. On the other had, the brokering forwarder may construct the header in accordance with the next NFP_id which corresponds to the branch_id and the NFP_id on the NFP mapping table when the branch_id of the downlink packet represents that there is a branch.

The brokering forwarder may include a VNF interface configured to receive the downlink packet from the VNF; a forwarding engine configured to receive the input packet from the forwarder; a classifier configured to detect NFP_id of the input packet or the downlink packet; and a mapper configured to transfer interface information corresponding to the NFP_id of the input packet by referring to the NFP interface table provided by the orchestrator to the VNF interface, obtain interface information corresponding to the NFP_id of the downlink packet by referring to the NFP interface table, and generate the header in accordance with the interface information, wherein the VNF interface may construct network interface or system interface in accordance with the interface information, and wherein the forwarder interface may transfer the output packet including the header through a path in accordance with the header.

The brokering forwarder may detect NFP_id included in the header of the input packet as NFP_id of the input packet when the NFP_id is included in the header of the input packet. On the other hand, the brokering forwarder may detect NFP_id corresponding to input port information of the input packet and the header of the input packet on the NFP mapping table as NFP_id of the input packet when the NFP_id is not included in the header of the input packet.

According to further another general aspect, a method for chaining a virtualized network function in a method for chaining a virtualized network function by a broker or a brokering forwarder of a system for chaining virtualized network function, includes: receiving an input packet; detecting NFP_id of the input packet by referring to a NFP mapping table provided by an orchestrator; transferring the NFP_id and data of the input packet to a virtualized network function (VNF); receiving a downlink packet including the NFP_id, branch_id and data from the VNF; constructing a header in accordance with the NFP_id or next NFP_id which corresponds to the branch_id on the NFP mapping table; and transferring data included in the downlink packet and an output packet including the header to the forwarder.

The constructing a header in accordance with the NFP_id or next NFP_id which corresponds to the branch_id on the NFP mapping table may include: constructing the header in accordance with the NFP_id when the branch_id of the downlink packet represents that there is no branch; and constructing the header in accordance with the next NFP_id which corresponds to the branch_id and the NFP_id on the NFP mapping table when the branch_id of the downlink packet represents that there is a branch.

The transferring the NFP_id and data of the input packet to a virtualized network function (VNF) may include: constructing network interface or system interface in accordance with the interface information which corresponds to the input packet by referring to the NFP interface table provided by the orchestrator; and transferring the NFP_id and data of the input packet to the VNF through the network interface or the system interface. The transferring data included in the downlink packet and an output packet including the header may include: constructing the header in accordance with interface information which corresponds to the downlink packet by referring to the NFP interface table provided by the orchestrator; and transferring data included in the downlink packet and an output packet including the header through a path in accordance with the header.

The detecting NFP_id of the input packet by referring to a NFP mapping table provided by an orchestrator may include: detecting NFP_id included in the header of the input packet as NFP_id of the input packet when the NFP_id is included in the header of the input packet; and detecting NFP_id corresponding to input port information of the input packet and the header of the input packet on the NFP mapping table as NFP_id of the input packet when the NFP_id is not included in the header of the input packet.

According to exemplary embodiments of the present disclosure, there is provided a system for chaining a virtualized network function which is able to provide pure functions of VNFs and the independence of each VNF from the system by separating chaining interfaces.

According to exemplary embodiments of the present disclosure, a system for chaining a virtualized network function allows reducing costs for the application of new chaining technologies by applying the new chaining technologies without changing or modifying an existing VNF.

Other features and aspects will be apparent from the following detailed description, the drawings, and the claims.

### BRIEF DESCRIPTION OF DRAWINGS

FIG. 1 is a diagram illustrating an example of a system for chaining a virtualized network function.

FIG. 2 is a diagram illustrating an example of NFP provided by a system for chaining a virtualized network function.

FIG. 3 is a diagram illustrating an example of packets received and transferred by a system for chaining a virtualized network function.

FIG. 4 is a diagram illustrating an example of a broker of a system for chaining a virtualized network function.

FIG. 5 is a diagram illustrating an example of information received/transferred by a broker and a VNF of a system for chaining a virtualized network function.

FIG. 6 is a diagram illustrating an example of implementations of a broker in a system for chaining a virtualized network function.

FIG. 7 is a diagram illustrating an example of a brokering forwarder of a system for chaining a virtualized network function.

FIG. 8 is a diagram illustrating a non-coupling example between forwarders performing different chaining methods in a conventional method for chaining a virtualized network functions.

FIG. 9 is a diagram illustrating a chaining example between VNFs through brokering forwarders which perform different chaining methods by a system for chaining a virtualized network function.

FIG. 10 is a diagram illustrating an example of processing multi-NFPs by a system for chaining a virtualized network function.

FIG. 11 is a diagram illustrating an example of performing a VNF branch process by a system for chaining a virtualized network function.

FIG. 12 is a flowchart illustrating an example of a process for providing a virtualized network function chaining for an uplink packet by a system for chaining a virtualized network function.

FIG. 13 is a flowchart illustrating an example of a process for providing a virtualized network function chaining for a downlink packet by a system for chaining a virtualized network function.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Since there can be a variety of permutations and embodiments of the following description, certain embodiments will be illustrated and described with reference to the accompanying drawings. This, however, is by no means to restrict the following description to certain embodiments, and shall be construed as including all permutations, equivalents and substitutes covered by the ideas and scope of the following description.

When one element is described as “transfer a signal” or “transmit a signal” to another element, it shall be construed as transfer or transmit a signal to the other element directly but also as possibly having another element in between.

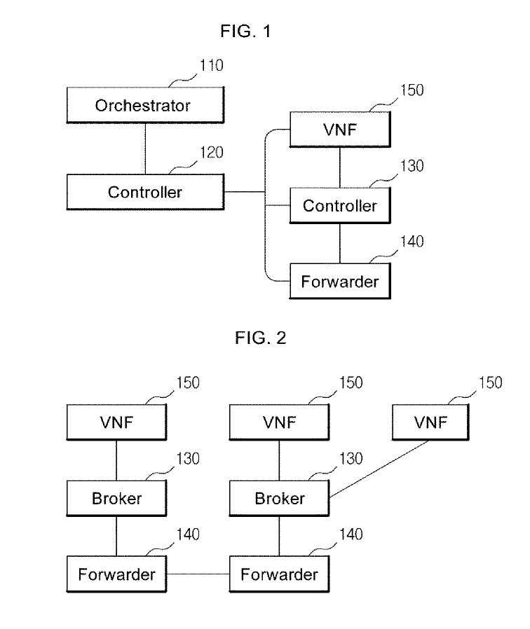

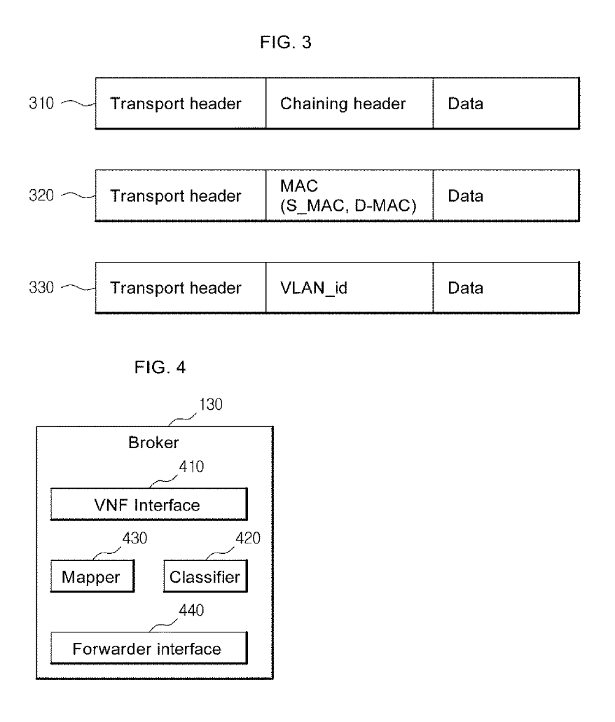

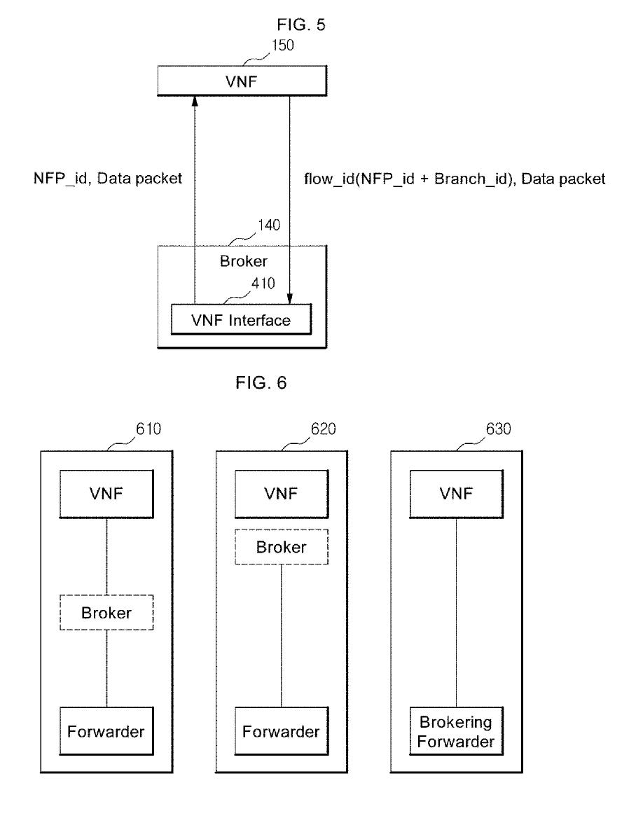

FIG. 1 is a diagram illustrating an example of a system for chaining a virtualized network function, FIG. 2 is a diagram illustrating an example of NFP provided by a system for chaining a virtualized network function. FIG. 3 is a diagram illustrating an example of packets received and transferred by a system for chaining a virtualized network function, FIG. 4 is a diagram illustrating an example of a broker of a system for chaining a virtualized network function, and FIG. 5 is a diagram illustrating an example of information received/transferred by a broker and a VNF of a system for chaining a virtualized network function.

A system for chaining a virtualized network function according to an example includes an orchestrator 110, a controller 120, a broker 130, a forwarder 140 and a VNF 150. FIG. 1 illustrates a system for chaining a virtualized network function including one forwarder 140, one broker 130 and one VNF 150 but it may include more than one forwarder 140, more than one broker 130 and more than one VNF 150. As shown in FIG. 2, the system for chaining a virtualized network function may include one or more forwarders 140 which are connected with each other. Here, each forwarder 140 may be connected through one or more VNFs 150 and one or more brokers 130. A packet received or transferred by each forwarder 140 may have a structure as shown in FIG. 3. For example, when a packet received or transferred by the forwarder 140 is a packet in accordance with a chaining header method, the packet may include a transport header, a chaining header and data as shown in 310 of FIG. 3. When a packet received or transferred by the forwarder 140 is a packet in accordance with a MAC chaining method, the packet may include a transport header, a MAC address and data as shown in 320 of FIG. 3. When a packet received or transferred by the forwarder 140 is a packet in accordance with a VLAN chaining method, the packet may include a transport header, VLAN_id and data as shown in 330 of FIG. 3. Hereinafter, a header for the NFP processing such as a chaining header, MAC, and VLAN_id is called as a NFP header. A packet transferred from the forwarder 140 to the VNF 150 is called as an uplink packet and a packet transferred from the VNF 150 to the forwarder 140 is called as a downlink packet. An overlay header which transfers a packet to a destination through network interface is called as a transport header.

The orchestrator 110 provides input port information, which represents an input port of a packet, and a NFP mapping table, in which the NFP header and NFP_id are mapped, to a classifier which will be explained below. The NFP mapping table may further include branch_id for a branch-typed VNF and NFP_id corresponding to the branch_id. Here, the orchestrator 110 may construct a new NFP for each branch, which may occur on the NFP, in addition to the NFP of the packet, which means that the orchestrator 110 constructs a new NFP for each branch_id and maps unique NFP_id for each new NFP to identify a NFP for each branch. A VNF provider may provide in advance a VNF descriptor including branch-typed VNF, if there is, the number of branches and branch information to the orchestrator 110. The branch information may include description about the branch_id and the branch. The description about the branch may describe that branch_id 0 among the branch ids, generated by the VNF operated by an intrusion detection system (IDS), is a normal packet and branch_id 1 is an abnormal packet

The orchestrator 110 may provide a NFP mapping table to the broker 130 through the controller 120. The orchestrator 110 may also provide NFP_id to the broker 130 through the controller 120 when a request for the NFP_id of an uplink packet is received to the broker 130 through the controller 120. The orchestrator 110 may provide the type of interface capable of transferring each NFP_id-mapped uplink packet or downlink packet and a NFP interface table including interface-related information such as network interface information and system interface information to the broker 130. In other words, when a packet including a transport header is transferred between the VNF 150 and the broker 130, the orchestrator 110 may provide network interface information required for generating the transport header to the broker 130. On the other hand, when the VNF 150 and the broker 130 are implemented in one system, the orchestrator 110 may provide system interface information required for transferring a packet in accordance with protocol in the system to the broker 130.

The NFP interface table which is provided to the broker 130 may be represented by Table 1 below for an uplink packet which is outputted to the VNF 150.

TABLE 1

| | | | |
|---|---|---|---|
| NFP_id | Interface type | Network interface | System interface |
| | (interface_type) | information | information |
| | | (network_interface) | (system_interface) |

The NFP interface table which is provided to the broker 130 may be represented by Table 2 below for a downlink packet. When the broker 130 and the forwarder 140 are connected with each other, the NFP interface table may provide a chaining type (chaining_type) and tunneling information (Tunneling_type, Tunnel_id) for transferring a packet from the broker 130 to the forwarder 140. When the broker 130 and the forwarder 140 are implemented in an integrated type, the NFP interface table may provide a chaining type and tunneling information for transferring a packet from the forwarder to a next forwarder corresponding to a next VNF.

TABLE 2

| | | | | | | | | |
|---|---|---|---|---|---|---|---|---|
| NFP_id | chaining_type | service_id | MAC | VLAN_id | Forwarder | Tunneling_type | Tunnel_id | output_port |
| | | | address | | address | | | |

The controller 120 may receive the NFP mapping table and the NFP interface table from the orchestrator 110 and transfer them to the broker 130. When a request is received from the broker 130, the controller 120 may transfer the request to the orchestrator 110, receive the corresponding answer from the orchestrator 110 and then transfer the answer to the broker 130.

The broker 130 may receive a packet from the VNF 150 and modify the packet to be fitted to the forwarder 140 to transfer the result to the forwarder 140. The broker 130 may receive a packet from the forwarder 140 and modify the packet into a form pre-defined by the VNF 150 to transfer the result to the VNF 150. Functions of the broker 130 will be explained in detail with reference to FIG. 4 below.

Referring to FIG. 4, the broker 130 includes a VNF interface 410, a classifier 420, a mapper 430, and a forwarder interface 440.

The VNF interface 410 may be connected with the VNF 150 to receive/transfer a packet. For example, when NFP_id for an uplink packet, information (network interface information or system interface information) and data are received from the mapper 430, the VNF interface 410 may connect to the VNF 150 in accordance to the interface information and transfer the NFP_id and the data to the VNF 150 as shown in FIG. 5. When flow_id for the downlink packet and data are received from the VNF 150, The VNF interface 410 may transfer the flow_id and the data to the classifier 420.

The classifier 420 may analyze the packet received from the forwarder interface 440 to identify NFP_id corresponding to the packet and transfer the NFP_id and the data to the mapper 430. For example, the classifier 420 may receive an uplink packet from the forwarder interface 440. The classifier 420 may analyze header information of the uplink packet to identify whether the uplink packet is a valid packet (a normal packet according to a predetermined format) or not. When it is determined as that it is valid, the classifier 420 may determine a chaining method of the uplink packet by referring to a NFP header of the header information. When the NFP header includes NFP_id (when a chaining method of the uplink packet is a chaining header method), the classifier 420 may extract the NFP_id from the header information of the uplink packet. On the other hand, when the NFP header does not include NFP_id, the classifier 420 may identify the input port where the uplink packet is received and the NFP_id corresponding to a VLAN_id or a MAC address included in the NFP header by referring to a NFP mapping table. Here, when the NFP mapping table is received from the orchestrator 110 and thus pre-stored, the classifier 420 may directly refer to the stored NFP mapping table. On the other hand, when NFP mapping table is not pre-received from the orchestrator 110, the classifier 420 may request to the orchestrator 110 to identify the NFP_id for the uplink packet. The classifier 420 may transfer the NFP_id and data of the uplink packet to the mapper 430.

The classifier 420 may also receive a downlink packet including data and flow_id from the VNF interface 410. The classifier 420 may extract NFP_id and branch_id of the downlink packet included in the flow_id. When the branch_id represents that there is a branch (for example, when the branch_id is not 0), the classifier 420 may obtain NFP_id corresponding to the branch_id by referring to the NFP mapping table or request to the orchestrator 110 to obtain NFP_id corresponding to the branch_id. The classifier 420 may transfer the obtained NFP_id and data to the mapper 430. On the other hand, when the branch_id represents that there is no branch (for example, when the branch_id is 0), the classifier 420 may determine that there is no branch for the downlink packet and transfer the NFP_id included in the flow_id and data to the mapper 430.

When the NFP_id of the uplink packet and data are received from the classifier 420, the mapper 430 may transfer network interface information or system interface information, which corresponds to the NFP_id and a NFP_id-mapped interface type, to the VNF interface 440. For example, the mapper 430 may pre-store NFP_id corresponding to the VNF 150 which is connected to each broker 130 and determine whether the NFP_id of the uplink packet corresponds to the NFP of the VNF 150 which is connected to the broker 130. When the NFP_id of the uplink packet corresponds to the NFP of the VNF 150 which is connected to the broker 130, the mapper 430 may determine an interface type corresponding to the NFP_id by referring to the NFP interface table. When the interface type corresponding to the NFP_id is a network interface, the mapper 430 may extract network interface information from the NFP interface table. When the interface type corresponding to the NFP_id is a system interface, the mapper 430 may extract system interface information from the NFP interface table. The mapper 430 may transfer the NFP_id, the network interface information or the system interface information, and data of the uplink packet to the VNF interface 410.

When NFP_id of a downlink packet and data are received from the classifier 420, the mapper 430 may extract VNF interface information of a next VNF to be chained through the NFP_id by referring to the NFP interface table. Here, the VNF interface information of the next VNF may include a chaining method, service_id of the header, an address of the next VNF, VLAN_id to go to the next VNF, and forwarder connection information to go to the next VNF. The forwarder connection information may include a forwarder address, tunneling information, port information to be outputted to the forwarder and the like. When a branch occurs to a path corresponding to the NFP_id, the service_id may be identification information which distinguishes the path where the packet is transferred to the next VNF from other paths. The mapper 430 may generate a mapper 430 by referring to the VNF interface information. Here, when the downlink packet follows a chaining header method, the mapper 430 may generate a NFP header by combining the NFP_id and the service_id. The mapper 430 may also modify the service_id to specify that the downlink packet is a packet to forward to a downlink packet. When the downlink packet follows a MAC method, the mapper 430 may construct a NFP header to have a MAC address of a next VNF, which is the MAC address corresponding to the NFP_id by referring to the NFP mapping table, as a target address. When the downlink packet follows a VLAN method, the mapper 430 may generate a NFP header including VLAN_id corresponding to the NFP_id by referring to the NFP mapping table, in which the VLAN_id is a predetermined VLAN_id to forward the downlink packet to the next VNF. After generating the NFP header, the mapper 430 may generate a transport header and output port information. Here, the transport header is information to transfer the downlink packet to a next forwarder which is thus independent from the next VNF so that address information of the next forwarder may be generated to include a destination address by, for example, a tunneling method. The mapper 430 may also obtain address information and tunneling information needed to generate the transport header from forwarder connection information. The output port information may represent a port to output the downlink packet from the forwarder interface 440. The mapper 430 may transfer the NFP header, the transport header, the output port information and the data to the forwarder interface 440.

The forwarder interface 440 may function as interface between the forwarder 140 and the broker 130. For example, when the NFP header, the transport header, the output port information and the data are received from the mapper 430, the forwarder interface 440 may construct a downlink packet including the NFP header, the transport header, and the data and transfer the downlink packet through a port in accordance with the output port information to the forwarder 140. When an uplink packet is received from the forwarder 140, the forwarder interface 440 may eliminate the transport header from the uplink packet and transfer the uplink packet from which the uplink packet is eliminated and input port information to the classifier 420.

Referring again to FIG. 1, the forwarder 140 may be connected with the broker 130 and another forwarder to transfer a packet. The forwarder 140 may classify packet flow through a method for processing path according to packets using legacy network control and a SDN technology such as Openflow, and perform NFP control according to each packet flow. For example, when a downlink packet is received from the forwarder interface 440, the forwarder 140 may forward the downlink packet to another forwarder 140. When an uplink packet is received from another forwarder, the forwarder 140 may transfer the uplink packet to the forwarder interface 440.

It is described above as shown in FIG. 1 that the broker 130 is located between the VNF 150 and the forwarder 140. However, it is not limited thereto. For example, the broker 130 may be implemented inside the forwarder 140 according to implementation methods. 3 Examples how the forwarder 140 is implemented will be explained below.

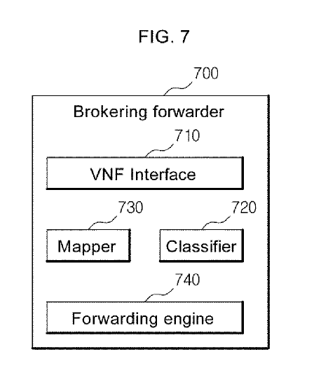

FIG. 6 is a diagram illustrating an example of implementations of a broker in a system for chaining a virtualized network function, and FIG. 7 is a diagram illustrating an example of a brokering forwarder of a system for chaining a virtualized network function. 610 Of FIG. 6 illustrates an example of the broker 130 which operates as an independent network entity. The broker 130 is explained with reference to FIG. 1 to FIG. 5.

620 Of FIG. 6 illustrates an example of the broker 130 embedded in a system in which the VNF 150 operates. Here, the broker 130 may be implemented to allow communication using system interface in between the broker 130 and the VNF 150 or using driver or library calls.

620 Of FIG. 6 illustrates an example of the broker 130 which is combined with the forwarder 140. Hereinafter, the forwarder 140 which is combined with the broker 130 is called as a brokering forwarder 700. In a system for chaining a virtualized network function with first two examples, it focuses on delivering packets from the broker 130 to the forwarder 140, while in a system for chaining a virtualized network function with the brokering forwarder 700, it may increase efficiency of packet deliveries by delivering packets to a next forwarder 140. Particularly, the brokering forwarder 700 may process a packet which includes a chaining header and a packet which does not include a chaining header at the same time so that it may decrease compatibility problems.

Structure of the brokering forwarder 700 may be explained in detail with reference to FIG. 7 below.

The brokering forwarder 700 may include a VNF interface 710, a classifier 720, a mapper 730, and a forwarding engine 740. Since functions of the VNF interface 710, the classifier 720 and the mapper 730 are similar to those described with the VNF interface 410, the classifier 420 and the mapper 430 in FIG. 1 to FIG. 3, identical functions about the VNF interface 710, the classifier 720 and the mapper 730 will be omitted.

When an uplink packet is received, the forwarding engine 740 may classify the uplink packet into a NPF header and data, and transfer input port information representing the port which has received the uplink packet and data information to the classifier 720. When the NFP header, the output port information and the data are received from the mapper 730, the forwarding engine 740 the NFP header and the data through a part in accordance with the output port information to another forwarder. Here, the forwarding engine 740 may be coupled with another forwarder through system interface. The forwarding engine 740 may thus find another forwarder which is connected to a next VNF through NFP_id and obtain a chaining type or tunneling information of the another forwarder by referring to a NFP interface table to transfer the NFP header and the data to the another forwarder through the obtained information.

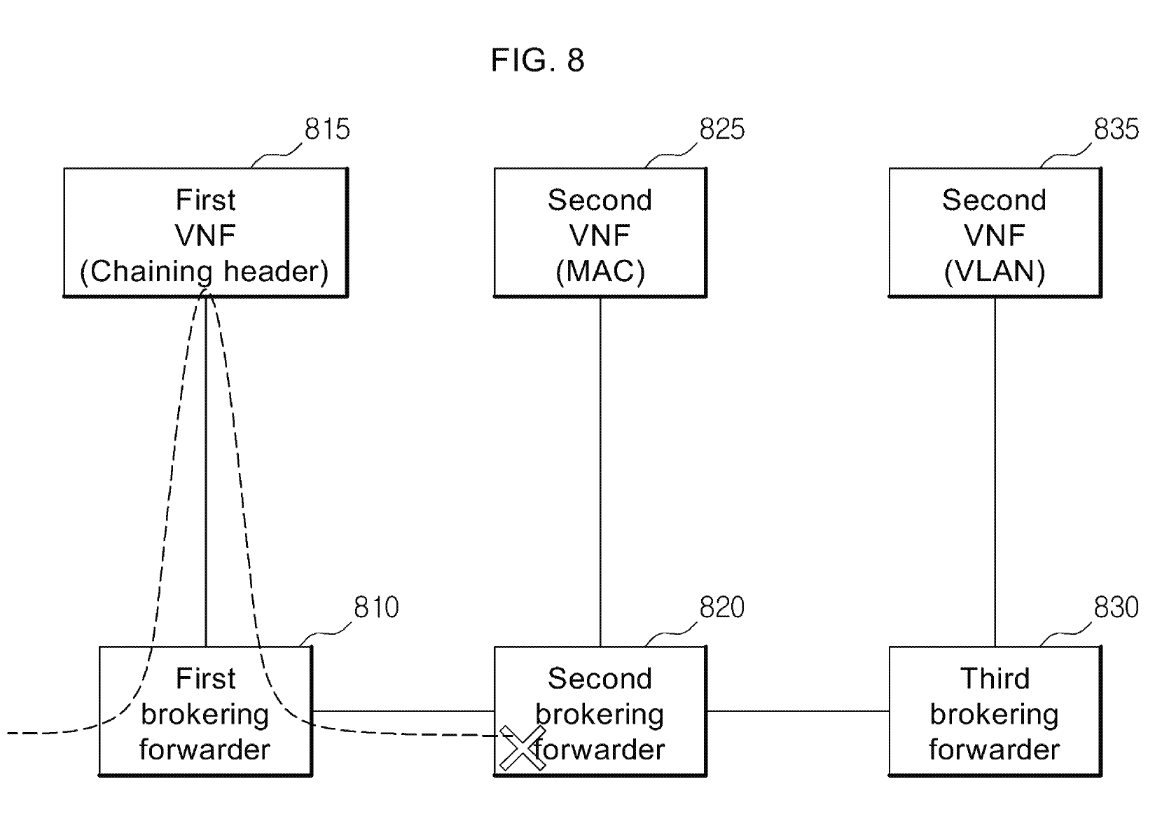

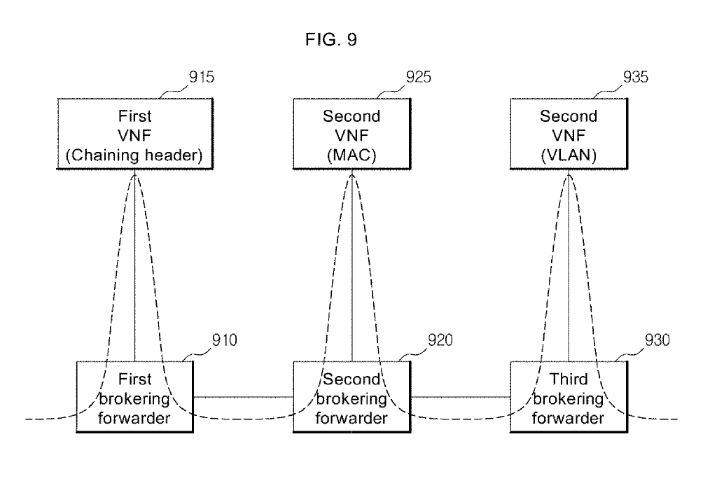

FIG. 8 is a diagram illustrating a non-coupling example between forwarders performing different chaining methods in a conventional method for chaining a virtualized network functions, and FIG. 9 is a diagram illustrating a chaining example between VNFs through brokering forwarders which perform different chaining methods by a system for chaining a virtualized network function.

As shown in FIG. 8, it is assumed that a NFP is constructed in which a packet is transferred from a first brokering forwarder 810 through a second brokering forwarder 820 to a third brokering forwarder 830. After a packet is transferred to a first VNF 815 through the first brokering forwarder 810, the first VNF 815 transfers the packet back to the first brokering forwarder 810. The first brokering forwarder 810 transfers the packet in accordance with a chaining header method to the second brokering forwarder 820. However, since the second brokering forwarder 820 transfers the packet in accordance with a MAC method, chaining for the packet cannot be performed. Even though the second brokering forwarder 820 transfers the packet to a second VNF 825, the second VNF 825 cannot process the packet in accordance with the chaining header method. Therefore, a conventional virtualized network function chaining method cannot provide NFPs variously compatible with a chaining method as shown in FIG. 8.

Referring to FIG. 9, even though different chaining methods are used together, a system for chaining a virtualized network function according to an example may construct NFPs. For example, after a packet is transferred to a first VNF 915 through a first brokering forwarder 910, the first VNF 915 may transfer the packet back to the first brokering forwarder 910. The first brokering forwarder 910 may transfer the packet which follows a chaining header method to a chaining header method. The chaining header method may classify a header of the packet using a classifier to obtain NFP_id corresponding to the packet. The second brokering forwarder 920 may transfer data with the NFP_id to a second VNF 925. The second VNF 925 may transfer data which is generated by performing a predetermined function using the data along with flow_id to the second brokering forwarder 920. In other words, the second brokering forwarder 920 may communicate with the second VNF 925 only using the NFP_id and the second VNF 925 may perform functions regardless of a chaining method of the packet. The second brokering forwarder 920 may input the NFP_id included in the flow_id using the classifier to a mapper. The second brokering forwarder 920 may determine whether a chaining type corresponding to the NFP_id is a VLAN method by referring to a NFP interface table through the mapper, construct a new NFP header as VLAN_id, and transfer the packet including the new NFP header to a third brokering forwarder 930. Since the packet including the VLAN_id is received, the third brokering forwarder 930 may perform VLAN bridging and transfer the packet to a third VNF 935.

As described above, even though a packet of any method is inputted to a forwarder, each VNF of the system for chaining a virtualized network function according to an example may receive the packet using NFP_id. Thus, each VNF may be implemented regardless of a chaining method.

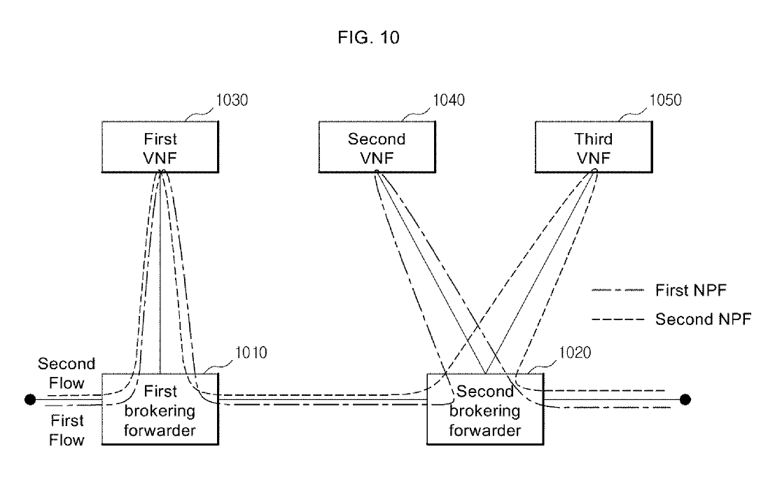

FIG. 10 is a diagram illustrating an example of processing multi-NFPs by a system for chaining a virtualized network function.

Referring to FIG. 10, a first flow may be transferred through a first NFP connected to the outside through a first VNF 1030 and a second VNF 1040. A second flow may be transferred through a second NFP connected to the outside through the first VNF 1030 and a third VNF 1050. Here, it is assumed that a first brokering forwarder 1010 and a second brokering forwarder 1020 perform chaining according to a MAC method. Thus, the first brokering forwarder 1010 may obtain information to transfer a packet to VNF of a next hop and a forwarder to perform normal chaining. If the first flow and the second flow are not transferred to two different ports, two flows may not be distinguished from each other. However, it is virtually impossible to map different input ports for all NFPs. When a new NFP is added, it is also unrealistic to generate an input port in real-time and construct a NFP by mapping flow in the generated input port.

In other words, there is no choice but flows corresponding to different NFPs have to use the same port. Here, when flows do not follow a chaining header method, headers of each packet are analyzed to identify NFPs for a normal chaining.

The first brokering forwarder 1010 may transfer a packet including NFP_id for a first flow and a second flow which are uplink packets to the first VNF 1030. Since the first VNF 1030 may perform functions of each flow to transfer a packet including NFP_id of each flow to the first brokering forwarder 1010, the first brokering forwarder 1010 may identify that each packet is one of the first flow and the second flow by referring to the NFP_id of the packet received from the first VNF 1030. In other words, even though each forwarder and each VNF receive packets corresponding to different NFPS through the same port, the NFP of each packet may be determined through the NFP_id.

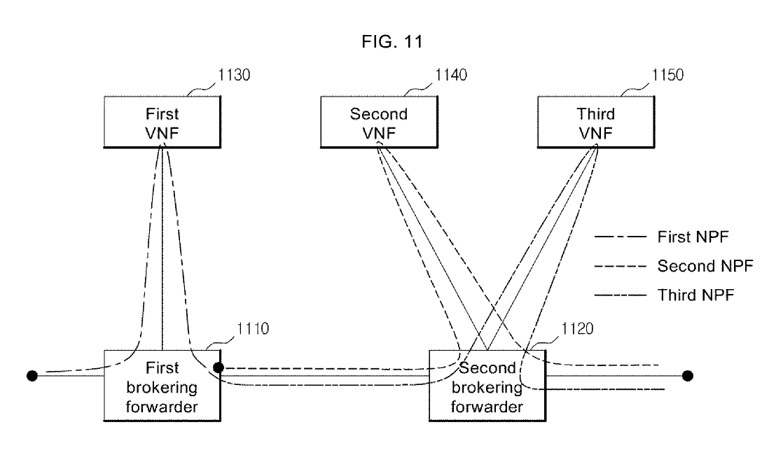

FIG. 11 is a diagram illustrating an example of performing a VNF branch process by a system for chaining a virtualized network function.

Referring to FIG. 11, a system for chaining a virtualized network function may process a branch which defers a transport path of a packet in accordance with result from that each VNF processes the packet.

For example, it is assumed that the first VNF 1130 is IDS. The IDS may classify packets into a normal packet and an abnormal packet based on the type of the packets. Here, the IDS has to process a branch which sets different transport paths of the normal packet and the abnormal packet. In other words, the first VNF 1130 may set NFPs to transfer a normal packet to a second VNF 1140 and an abnormal packet to a third VNF 1150.

A first brokering forwarder 1110 may receive flow_id and data from the first VNF 1130 through a first NFP. The first brokering forwarder 1110 may determine a new NFP_id corresponding to branch_id and NFP_id including in the flow_id by referring to a NFP mapping table. When data is a normal packet, the first VNF 1130 may transfer flow_id including branch_id set as “1” to the first brokering forwarder 1110. The first brokering forwarder 1110 may set a NFP corresponding to a new NFP_id mapped to NFP_id included in the flow_id and the branch_id 1 as a path to transfer data. In other words, the first brokering forwarder 1110 may set a second NFP to transfer the normal packet according to the branch_id 1. On the other hand, when data is an abnormal packet, the first VNF 1130 may transfer flow_id including branch_id which is set as “2” to the first brokering forwarder 1110. The first brokering forwarder 1110 may set a third NFP corresponding to a new NFP_id mapped to NFP_id included in the flow_id and the branch_id 2 as a path to transfer data. In other words, the first brokering forwarder 1110 may set a NFP to transfer the abnormal packet according to the branch_id 2.

Therefore, each VNF may perform branch processing regardless of a chaining method of packets and the forwarder 140 or the brokering forwarder 740 may transfer a packet to a next forwarder in accordance with new NFP_id of each branch to construct NFPs of each branch.

Advantages of the system for chaining a virtualized network function using brokering forwarders have been described with reference to FIG. 9 to FIG. 11. However, the system for chaining a virtualized network function including the broker and the forwarder of FIG. 1 may also provide the above-mentioned advantages.

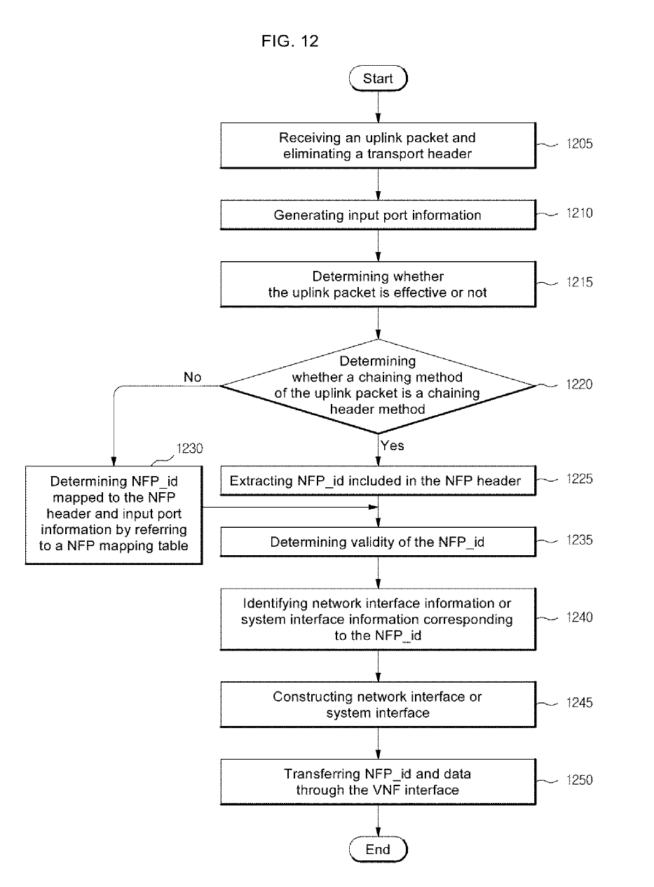

FIG. 12 is a flowchart illustrating an example of a process for providing a virtualized network function chaining for an uplink packet by a system for chaining a virtualized network function.

Referring to FIG. 12, in step 1205, the broker 130 or the brokering forwarder 700 receives an uplink packet and eliminates a transport header from the uplink packet.

In step 1210, the broker 130 or the brokering forwarder 700 generates input port information representing a port which has received the uplink packet.

In step 1215, the broker 130 or the brokering forwarder 700 determines whether the uplink packet is effective or not using a classifier.

In step 1220, the broker 130 or the brokering forwarder 700 identifies a NFP header of the uplink packet through the classifier to determine whether a chaining method of the uplink packet is a chaining header method.

When the chaining method of the uplink packet is a chaining header method, in step 1225, the broker 130 or the brokering forwarder 700 extracts NFP_id included in the NFP header through the classifier.

When the chaining method of the uplink packet is not a chaining header method, in step 1230, the broker 130 or the brokering forwarder 700 determines NFP_id mapped to the NFP header and input port information by referring to a NFP mapping table through the classifier.

In step 1235, the broker 130 or the brokering forwarder 700 determines validity of the NFP_id through the classifier.

In step 1240, the broker 130 or the brokering forwarder 700 identifies network interface information or system interface information corresponding to the NFP_id by referring to a NFP interface table through the mapper.

In step 1245, the broker 130 or the brokering forwarder 700 constructs network interface or system interface in accordance with the network interface information or the system interface information through VNF interface.

In step 1250, the broker 130 or the brokering forwarder 700 transfers NFP_id and data to the VNF 150 through the VNF interface. In other words, the broker 130 or the brokering forwarder 700 transfers NFP_id and data to the VNF 150 through the network interface or the system interface constructed through the VNF interface.

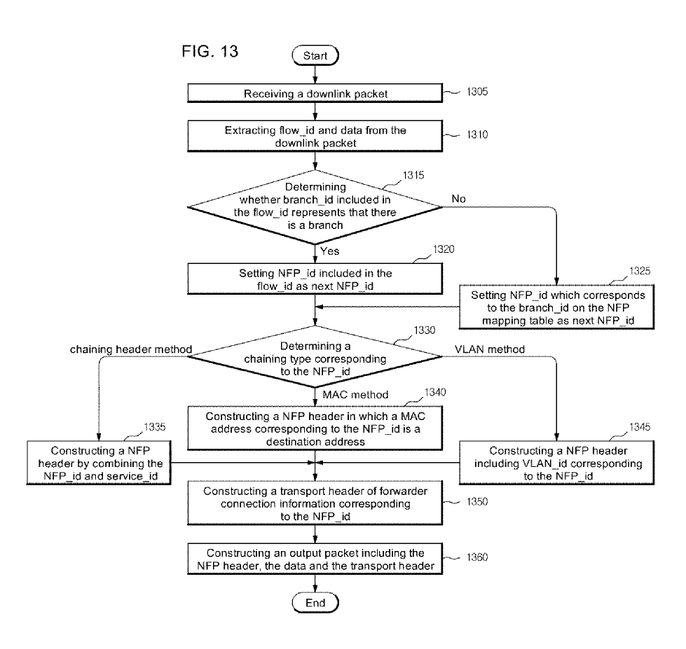

FIG. 13 is a flowchart illustrating an example of a process for providing a virtualized network function chaining for a downlink packet by a system for chaining a virtualized network function.

In step 1305, the broker 130 or the brokering forwarder 700 receives a downlink packet from VNF. Here, when the downlink packet includes a transport header (when the downlink packet is transferred through network interface), the broker 130 or the brokering forwarder 700 eliminate the transport header from the downlink packet.

In step 1310, the broker 130 or the brokering forwarder 700 extracts flow_id and data from the downlink packet using the classifier.

In step 1315, the broker 130 or the brokering forwarder 700 determines whether branch_id included in the flow_id represents that there is a branch through the classifier. For example, the broker 130 or the brokering forwarder 700 may determine whether there is a branch or not based on that branch_id included in the flow_id is 0.

When the branch_id included in the flow_id represents that there is no branch, in step 1320, the broker 130 or the brokering forwarder 700 may set NFP_id included in the flow_id as next NFP_id which is NFP_id to set NPF to which the packet is transferred afterwards.

When the branch_id included in the flow_id represents that there is a branch, In step 1325, the broker 130 or the brokering forwarder 700 sets NFP_id which corresponds to the branch_id and the NFP_id on the NFP mapping table as next NFP_id.

In step 1330, the broker 130 or the brokering forwarder 700 determines a chaining type corresponding to the NFP_id, which is the next VNF, by referring to a NFP interface table through the mapper

When the chaining type corresponding to the next VNF is a chaining header method, in step 1335, the broker 130 or the brokering forwarder 700 constructs a NFP header by combining the NFP_id and service_id.

When the chaining type corresponding to the next VNF is a MAC method, in step 1340, the broker 130 or the brokering forwarder 700 constructs a NFP header in which a MAC address corresponding to the NFP_id is a destination address by referring to a NFP interface table.

When the chaining type corresponding to the next VNF is a VLAN method, in step 1345, the broker 130 or the brokering forwarder 700 constructs a NFP header including VLAN_id corresponding to the NFP_id by referring to the NFP interface table.

In step 1350, the broker 130 or the brokering forwarder 700 constructs a transport header of forwarder connection information corresponding to the NFP_id.

In step 1360, the broker 130 or the brokering forwarder 700 constructs an output packet including the NFP header, the data and the transport header. Here, the broker 130 transfers the output packet to another forwarder through the forwarder connected to the broker 130 and an output port corresponding to the NFP_id based on the transport header. The brokering forwarder 700 also directly transfer the packet to another forwarder through the output port corresponding to the NFP_id based on the transport header.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A system for chaining a virtualized network function comprising:
a forwarder configured to receive an input packet; and
a broker configured to detect NFP_id of the input packet by referring to a network forwarding path (NFP) mapping table provided by an orchestrator and transfer the NFP_id and data of the input packet to a virtualized network function (VNF),
wherein the broker receives a downlink packet including the NFP_id, branch_id and data from the VNF, constructs a header in accordance with the NFP_id or next NFP_id which corresponds to the branch_id on the NFP mapping table, and transfers an output packet including data included in the downlink packet and the header to the forwarder,
wherein the forwarder transfers the output packet in accordance with the header of the output packet.

2. The system for chaining a virtualized network function of claim 1, wherein the broker constructs the header in accordance with the NFP_id when the branch_id of the downlink packet represents that there is no branch,
wherein the broker constructs the header in accordance with the next NFP_id which corresponds to the branch_id and the NFP_id on the NFP mapping table when the branch_id of the downlink packet represents that there is a branch.

3. The system for chaining a virtualized network function of claim 1, wherein the broker comprises:
a VNF interface configured to receive the downlink packet from the VNF;
a forwarder interface configured to receive the input packet from the forwarder;
a classifier configured to detect NFP_id of the input packet or the downlink packet; and
a mapper configured to transfer interface information corresponding to the NFP_id of the input packet by referring to the NFP interface table provided by the orchestrator to the VNF interface, obtain interface information corresponding to the NFP_id of the downlink packet by referring to the NFP interface table, and generate the header in accordance with the interface information,
wherein the VNF interface constructs network interface or system interface in accordance with the interface information,
wherein the forwarder interface transfers the output packet including the header to the forwarder.

4. The system for chaining a virtualized network function of claim 1, wherein the broker detects NFP_id included in the header of the input packet as NFP_id of the input packet when the NFP_id is included in the header of the input packet, and
wherein the broker detects NFP_id corresponding to input port information of the input packet and the header of the input packet on the NFP mapping table as NFP_id of the input packet when the NFP_id is not included in the header of the input packet.

5. A system for chaining a virtualized network function comprising:
an orchestrator configured to provide a NFP mapping table; and
a brokering forwarder configured to receive an input packet, detect NFP_id of the input packet by referring to the NFP mapping table, and transfer the NFP_id and data of the input packet to a virtualized network function (VNF),
wherein the brokering forwarder receives a downlink packet including the NFP_id, branch_id and data from the VNF, generates a header corresponding to the NFP_id or next NFP_id which corresponds to the branch_id on the NFP mapping table, and transfer an output packet including data included in the downlink packet and the header through a path in accordance with the header.

6. The system for chaining a virtualized network function of claim 5, wherein the brokering forwarder constructs the header in accordance with the NFP_id when the branch_id of the downlink packet represents that there is no branch, and
wherein the brokering forwarder constructs the header in accordance with the next NFP_id which corresponds to the branch_id and the NFP_id on the NFP mapping table when the branch_id of the downlink packet represents that there is a branch.

7. The system for chaining a virtualized network function of claim 5, wherein the brokering forwarder comprises:
a VNF interface configured to receive the downlink packet from the VNF;
a forwarding engine configured to receive the input packet from the forwarder;
a classifier configured to detect NFP_id of the input packet or the downlink packet; and
a mapper configured to transfer interface information corresponding to the NFP_id of the input packet by referring to the NFP interface table provided by the orchestrator to the VNF interface, obtain interface information corresponding to the NFP_id of the downlink packet by referring to the NFP interface table, and generate the header in accordance with the interface information,
wherein the VNF interface constructs network interface or system interface in accordance with the interface information,
wherein the forwarder interface transfers the output packet including the header through a path in accordance with the header.

8. The system for chaining a virtualized network function of claim 5, wherein the brokering forwarder detects NFP_id included in the header of the input packet as NFP_id of the input packet when the NFP_id is included in the header of the input packet, and
wherein the brokering forwarder detects NFP_id corresponding to input port information of the input packet and the header of the input packet on the NFP mapping table as NFP_id of the input packet when the NFP_id is not included in the header of the input packet.

9. A method for chaining a virtualized network function in a method for chaining a virtualized network function by a broker or a brokering forwarder of a system for chaining a virtualized network function, the method comprising:
receiving an input packet;
detecting NFP_id of the input packet by referring to a NFP mapping table provided by an orchestrator;
transferring the NFP_id and data of the input packet to a virtualized network function (VNF);
receiving a downlink packet including the NFP_id, branch_id and data from the VNF;
constructing a header in accordance with the NFP_id or next NFP_id which corresponds to the branch_id on the NFP mapping table; and
transferring an output packet including the data included in the downlink packet and the header to the forwarder.

10. The method for chaining a virtualized network function of claim 9, wherein the constructing a header in accordance with the NFP_id or next NFP_id which corresponds to the branch_id on the NFP mapping table comprises:
constructing the header in accordance with the NFP_id when the branch_id of the downlink packet represents that there is no branch; and
constructing the header in accordance with the next NFP_id which corresponds to the branch_id and the NFP_id on the NFP mapping table when the branch_id of the downlink packet represents that there is a branch.

11. The method for chaining a virtualized network function of claim 9, wherein the transferring the NFP_id and data of the input packet to a virtualized network function (VNF) comprises:
constructing network interface or system interface in accordance with the interface information which corresponds to the input packet by referring to the NFP interface table provided by the orchestrator; and
transferring the NFP_id and data of the input packet to the VNF through the network interface or the system interface, and
wherein the transferring an output packet including the data included in the downlink packet and the header comprises:
constructing the header in accordance with interface information which corresponds to the downlink packet by referring to the NFP interface table provided by the orchestrator; and
transferring an output packet including the data included in the downlink packet and the header through a path in accordance with the header.

12. The method for chaining a virtualized network function of claim 9, wherein the detecting NFP_id of the input packet by referring to a NFP mapping table provided by an orchestrator comprises:
detecting NFP_id included in the header of the input packet as NFP_id of the input packet when the NFP_id is included in the header of the input packet; and
detecting NFP_id corresponding to input port information of the input packet and the header of the input packet on the NFP mapping table as NFP_id of the input packet when the NFP_id is not included in the header of the input packet.
